(19) United States
(12) Patent Application Publication
(10) Pub. No.: US 2008/0063482 A1
(43) Pub. Date: Mar. 13, 2008

(54) DISC-SHAPED MILL CUTTING TOOL

(75) Inventor: Achim Engfer, Wulfsen (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Fette GmbH, Schwarzenbek (DE)

(21) Appl. No.: 11/851,691

(22) Filed: Sep. 7, 2007

(30) Foreign Application Priority Data
Sep. 9, 2006 (DE) 10 2006 042 468.9

(51) Int. Cl. B23B 27/12

(52) U.S. Cl. 408/59

(57) ABSTRACT

A disc-shaped mill cutting tool, with a disc-shaped main body which has a central axial through bore for the accommodation of a drive shaft as well as a plurality of pockets for the accommodation of cutting inserts on its perimeter, wherein chip spaces are associated to the pockets and a channel system is arranged between the central through bore and the chip spaces for the passage of cooling fluid which emerges in the chip spaces, characterised in that the disc-shaped main body is formed by at least two sub-discs coaxially sitting close together, which form a concentrically arranged ring channel between themselves, which is connected to the through bore via at least one connection channel, and the ring channel is connected to the chip spaces via relatively short bore portions.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

It is known to supply mill cutting tools with a cooling fluid. One possibility of supply takes place via a so-called inside cooling. In this, the cooling fluid is conveyed via the spindle or shaft of the machine tool, and then conveyed to the cutting edges via a suitable channel system in the tool.

Disc-shaped mill cutting tools are known in which cutting inserts are fixed on single or plural disc-shaped main bodies (a duplex tooth-form milling cutter, for instance) in correspondingly shaped pockets on the perimeter. Chip spaces are associated to the cutting inserts or the accommodation pockets for them, respectively.

It is known to connect the chip spaces with the central through bore in the main body via radial channels, through which the fluid supplied via the shaft or the spindle can reach the individual chip spaces, and by doing so the cutting inserts. At big tools in particular, very deep holes with relatively small diameter, have to be drilled or eroded. Such a manufacturing process is sumptuous, and the exit openings in the chip spaces can often not be selected such that the cooling fluid is optimally supplied to the cutting insert.

The present invention is based on the objective to provide a disc-shaped mill cutting tool in which the manufacturing expenditure for the provision of an inside cooling is reduced and the cooling as a whole is made more effective.

### BRIEF SUMMARY OF THE INVENTION

In the mill cutting tool of the present invention, the disc-shaped main body is formed by two sub-discs coaxially sitting close together, which form a concentrically arranged ring channel between themselves. The ring channel is connected to the through bore via at least one connection channel, and therefore it can be connected to the cooling fluid supply in the shaft or spindle for the mill cutting tool. The ring channel may be situated relatively near to the chip spaces. Therefore, only relatively short bore portions are necessary in order to connect the ring channel with the respective chip spaces. For instance, the bore portions have a length which is only a fraction of the length of the connection channel.

Making an inside cooling according to the present invention in disc-shaped mill cutting tools has advantages. It is relatively inexpensive to produce connection channels and the ring channel in sub-discs, by mill-cutting processing for instance. Only the relatively short bore portions have to be drilled. Thus, the manufacture expenditure for an inside cooling is significantly reduced in the mentioned mill cutting tools.

The relatively short bore portions can be brought in such that they emerge on the most favourable sites in the chip spaces in order to provide for effective cooling of the cutting edges. By doing so, the inside cooling provided in the invention is more effective.

In one embodiment of the present invention, it is provided that the connection channel and/or the bore portions is/are arranged at an angle with respect to the radius, such that the flowing cooling fluid is deflected about an angle of <90°. With such a measure, a venturi effect can be prevented, which would have the effect that the fluid is not only not lead to the chip spaces, but in the contrary air is aspirated via the bore portions.

In a further embodiment of the present invention, it is provided that the flow areas of connection channel (A1), ring channel (A2) and bore portions (A3) are dimensioned such that A1>A2>A3 is valid. In this way, it is made sure that with a predetermined pressure of a source for cooling fluid, an optimum cooling of the cutting edges on the mill cutting tool is maintained.

In another embodiment of the present invention, it is provided that the bore portions are connected with the ring channel on locations which have a distance to that location at which the connection channel runs out into the ring channel. Through this, it is avoided that for instance that bore portion which is connected to the ring channel immediately in the vicinity of the connection channel gets more cooling fluid than the neighbouring ones. In order to supply the ring channel sufficiently, it is sufficient to provide two diametrical connection channels, for instance.

The present invention is particularly suited for tooth-form milling cutters. In a divided tooth-form milling cutter, both discs together may form the ring channel. In an one-piece tooth-form milling cutter, the second sub-disc can be formed by a connection flange.

The ring channel can either be formed in one sub-disc only, or half-wise or partially in both sub-discs. It is obvious that the sub-discs are pressed and screwed against each other and that there are sealing means which prevent any escape of the cooling fluid.

### BRIEF DESCRIPTION OF SEVERAL VIEWS OF THE DRAWINGS

Examples of the realisation of the invention are explained in more detail by means of drawings in the following.

FIG. 1 shows a two-piece duplex tooth-form milling cutter of the present invention in a disassembled position.

FIG. 2 shows a perspective partial view of a sub-disc of the tooth-form milling cutter of FIG. 1.

FIG. 3 shows an one-piece tooth-form milling cutter of the present invention in a perspective representation.

FIG. 4 shows the side view of the tooth-form milling cutter disc of FIG. 3 in a partial view.

FIG. 5 shows schematically a channel system for an inside cooling of a mill cutting tool of the present invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

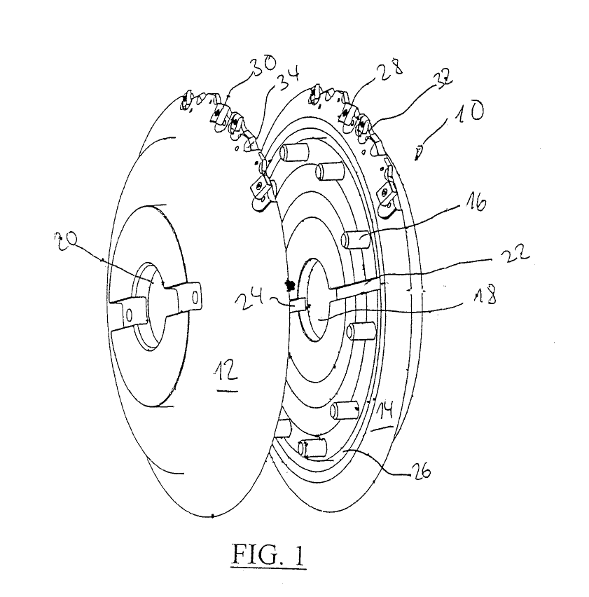

In FIG. 1, a duplex tooth-form milling cutter is depicted with two disc-shaped main bodies 12, 14, which are assembled coaxially or concentrically, respectively, wherein screws 16 of the main body 14 co-operate with not shown threaded bores of the main body 12 in order to connect the sub-discs 12, 14 into one unit. The sub-discs 12, 14 have coaxial through bores 18, 20, wherein the through bore 18 is in communication with two opposing connection channels 22, 24 which are machined radially into the main body 14. The connection channels 22, 24 can communicate with channels in a spindle or a shaft, which is a part of the machine tool, and which communicate with a source for cooling fluid. For instance, the cooling fluid is a gas or a liquid, respectively.

On the other end, the connection channels 22, 24 communicate with a ring channel 26, which is concentrically machined on the inner side of the disc-shaped main body 14.

On the perimeter of the disc-shaped main bodies 12, 14, accommodation pockets are formed for the accommodation of cutting inserts 28 or 30, respectively, which are fixed in the accommodation pockets by screwing. The cutting inserts 28, are alternately arranged on the perimeter of the main bodies 12, 14. Chip spaces 32, 34 are associated to the cutting inserts 28, 30.

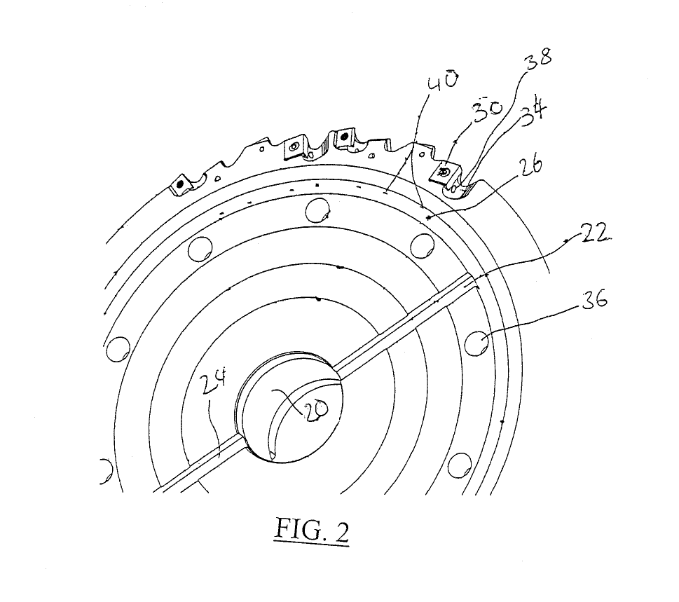

In FIG. 2, the inner side of the main body 12 is depicted with threaded bores 36 for the accommodation of the screws 16. Even in the main body 12, a ring channel 26 is formed and diametrically opposing connection channels 22, 24 are provided, which are brought into coincidence with the connection channels 22, 24 when the main bodies 12, 14 are set against each other.

As can be seen from FIG. 2 in particular, bore portions are formed between the ring channel 26 and the chip spaces, from which the end can be recognised in the chip space 34 at 38 and the beginning in the ring channel 26 at 40, for instance. When a cooling fluid is supplied under pressure via the not shown spindle or shaft, it reaches the connection channels 22, 24 and from there the ring channel 26, and from the latter it can flow to the chip spaces 32, 34 of the disc-shaped main bodies 12, 14 via the numerous bore portions, in order to cool the cutting edges of the cutting inserts in a suitable manner.

As can be recognised, the connection channels 22, 24 and also the ring channel 26 can be made by simple mill cutting processing. Only the bore portions have to be made with drilling tools. As the bore portions are short, they can be arranged on the optimal location for providing an efficient cooling.

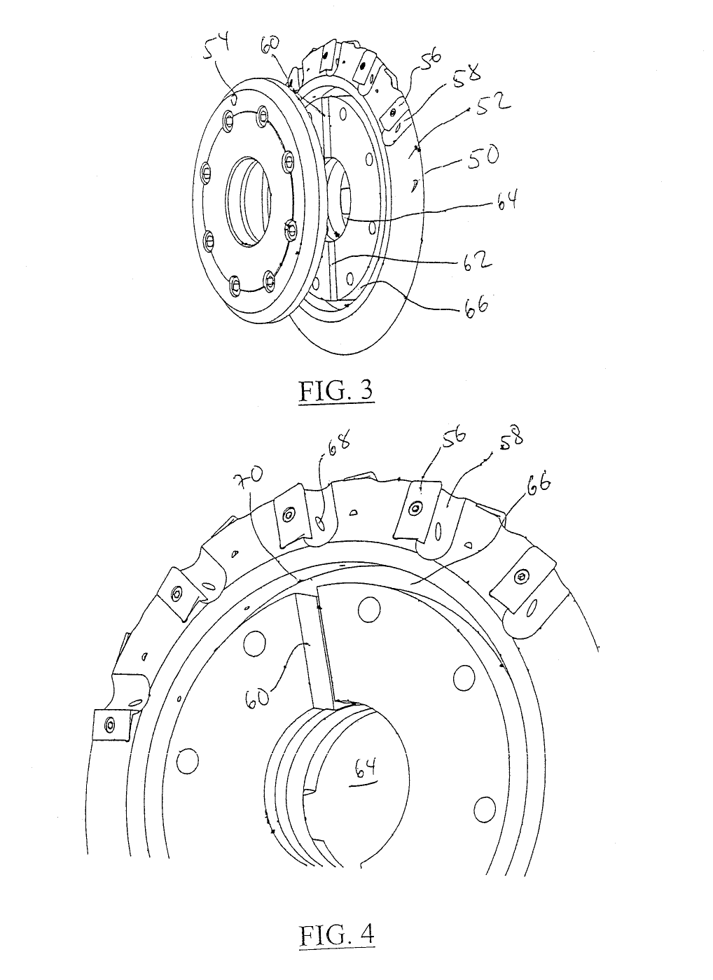

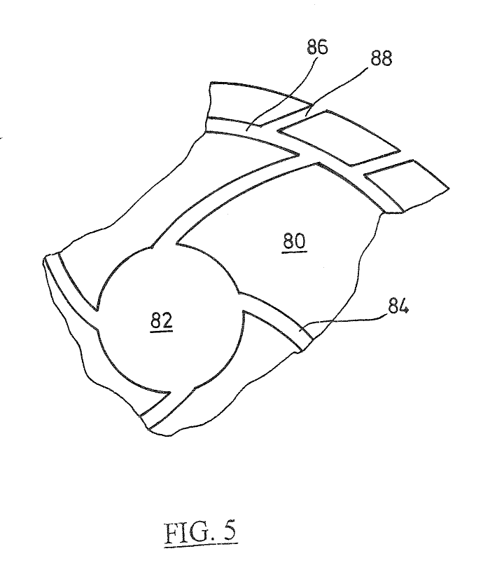

In FIGS. 3 and 4, an one-piece form milling cutter 50 is depicted with a disc-shaped main body 52 and a separate attachment flange 54, which is connected to the main body 52 via a suitable screw joint, to which will not be incurred in more detail. Again, on the perimeter of the main body 50 sit alternately cutting inserts 56, as is per se known, to which chip spaces 58 are associated. In the main body 52, diametrically opposing connection channels 60, 62 are formed, which communicate with the central through bore 64 and on the other end with a ring channel 66. The ring channel 66 on its part communicates with bore portions which turn out in the chip spaces 58. The orifice end can be recognised at 68 and the beginning at 70 in FIG. 4. The cooling principle or the channel system, respectively, is comparable to that one of FIGS. 1 and 2.

In FIG. 5, a main body for a mill cutting tool is indicated at 80, without details being shown. One recognises the central through bore 82 for the accommodation of a spindle or a shaft. The through bore 82 communicates with four connection channels 84, which are machined into the side surface of the main body 80. They extend slightly deflected in an arcuate form from the radius, which runs through the beginning point of the connection channels 84. The connection channels 84 communicate with a ring channel 86, from which bore portions 88 run to individual, not shown chip spaces. As can be recognised, the end of the connection channel 84 is arranged approximately between two bore portions 88, so that the cooling fluid flowing through the connection channel 84 does not immediately hit a bore portion 88. In addition, the bore portions 88 run slantly to the ring channel 86, so that the deflection of the fluid takes place about an angle of <90°. Through this, a suction nozzle effect in the flow of the fluid in the ring channel 86 is prevented, which otherwise would aspirate air via the bore portions 88.

Moreover, the connection channels 84 and also the bore portions 88 can have a diminution of the flow area near to their downstream end, in order to increase the fluid in its velocity and with this the pressure.

Preferably, the bore portions have a very small diameter in order to avoid cloggings. Moreover, it is obvious that a sufficient sealing is existent for the assembly of the sub-discs in the embodiments of FIGS. 1 to 4, which takes care that the fluid flows only in the preset channel system and does not escape to the exterior, except at the locations provided for this.

As can be recognised without further ado, the channel system can be manufactured very simply. In addition, the channels and bores can be made without fins to a large extent, so that resistances do not impede the flow of the cooling fluid.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A disc-shaped mill cutting tool, with a disc-shaped main body, which has a central axial through bore for the accommodation of a drive shaft as well as a plurality of pockets for the accommodation of cutting inserts on its perimeter, wherein chip spaces are associated to the pockets and a channel system is arranged between the central through bore and the chip spaces for the passage of cooling fluid which emerges in the chip spaces, characterised in that the disc-shaped main body is formed by at least two sub-discs (12, 14, 52, 54) coaxially sitting close together, which form a concentrically arranged ring channel (26, 66) between themselves, which is connected to the through bore (18, 20, 64) via at least one connection channel (22, 24, 60, 62), and the ring channel is connected to the chip spaces (32, 34, 58) via relatively short bore portions.

2. A mill cutting tool according to claim 1, characterised in that the connection channel (84) and/or the bore portions (88) is/are arranged at an angle with respect to the radius, such that the flowing cooling fluid is deflected about an angle of <90°.

3. A mill cutting tool according to claim 1, characterised in that the flow areas of connection channel (84), ring channel (86) and bore portions (88) decrease in this order.

4. A mill cutting tool according to claim 1, characterised in that the bore portions (88) are connected with the ring channel (86) on locations which have a distance to that location at which the connection channel (84) runs out into the ring channel (86).

5. A mill cutting tool according to claim 1, characterised in that the sub-discs (12, 14) form a duplex tooth-form milling cutter.

6. A mill cutting tool according to claim 1, characterised in that one sub-disc is formed by an attachment flange (54).

7. A mill cutting tool according to claim 1, characterised in that the ring channel (66) is formed in only one sub-disc.

8. A mill cutting tool according to claim 1, characterised in that the ring channel (26) is formed in both sub-discs.

9. A mill cutting tool according to claim 1, characterised in that annular control surfaces of the sub-discs are executed as sealing surfaces.

10. A mill cutting tool according to claim 1, characterised in that sealings are incorporated into the annular contact surfaces of the sub-discs.
